(19) United States
(12) Patent Application Publication
(10) Pub. No.: US 2002/0042732 A1
(43) Pub. Date: Apr. 11, 2002

(54) Communication system and method for providing customer assistance

(76) Inventor: Martin Tasler, Erlangen (DE)

Correspondence Address: LYON & LYON LLP, 633 WEST FIFTH STREET, SUITE 4700, LOS ANGELES, CA, 90071, US

(21) Appl. No.: 09/791,655

(22) Filed: Feb. 26, 2001

(30) Foreign Application Priority Data
Oct. 9, 2000 (DE) 100 49 825.6

(51) Int. Cl. G06F 17/60; G06F 15/16

(52) U.S. Cl. 705/10; 709/218; 705/7; 705/14

(57) ABSTRACT

The invention provides a system and method for operating a communication system in which a central computer recognizes that a customer computer has retrieved an offer page for at least one offer from a supplier, receives at least one report of operating actions performed on the customer computer relative to the offer page, and evaluates the reported operating actions.

### BACKGROUND OF THE INVENTION

1. Field of the Invention

The invention relates to a method for operating a communication system having at least one customer computer and a central computer which can be interconnected for communication of an offer page via a network.

2. Related Art

A client computer can be used to retrieve offer pages from a wide variety of suppliers with offers relating to products and/or services via the Internet, said offer pages being stored on servers. In this context, the offer pages retrieved usually have a virtual shopping basket that can be filled with products and/or services that are intended for purchase. To order the offers which are in the virtual shopping basket, a mask is opened on the offer page retrieved and, to place the order, a delivery address and a credit card number and/or a customer number, if there is one, need to be entered in said mask. Once the aforementioned order has been sent off, the order is processed, for example an ordered product is delivered. In this context, studies have shown that, in a large number of the procedures, despite the virtual shopping basket being filled, the order procedure is not completed, i.e. no order is placed for one of the offers, because customers using the client computer are not able to carry out all the steps until ordering is successful.

### SUMMARY OF THE INVENTION

The object of the invention is therefore to provide an improved method of the type mentioned initially which can be used, among other things, to increase a number of successfully completed ordering procedures.

The invention provides a method for operating a communication system by recognizing, via a central computer, that a customer computer has retrieved an offer page for at least one offer from a supplier; receiving, via the central computer, at least one report of operating actions performed on the customer computer relative to the offer page; evaluating, via the central computer, the reported operating actions; and offering interactive assistance to the customer computer when the evaluating step indicates with a prescribable degree of probability that the customer computer will not enter an order.

The invention further provides a communication system comprising a server configured to recognize that a customer computer has retrieved an offer page for a product or service; receive at least one report of operating actions performed on the customer computer in a context of the offer page; evaluate the operating actions; and offer interactive assistance to the customer computer when the evaluating step indicates with a prescribable degree of probability that the customer computer will not enter an order.

This makes it possible, in the event of the threat of a purchase being canceled, for the supplier to intervene and to get the customer to enter an order after all, for example by talking to him individually in an advisory capacity.

### BRIEF DESCRIPTION OF THE DRAWINGS

Other advantages, features and details of the invention can be found in the illustrative embodiments of the invention which are described below with the aid of the drawings, in which:

FIG. 1 shows a flowchart of a method for operating a communication system for one embodiment,

FIG. 2 shows a communication system for one embodiment, and

FIG. 3 shows another flowchart, for one embodiment, of ascertaining reference records for the flowchart in FIG. 1.

### DETAILED DESCRIPTION OF THE INVENTION

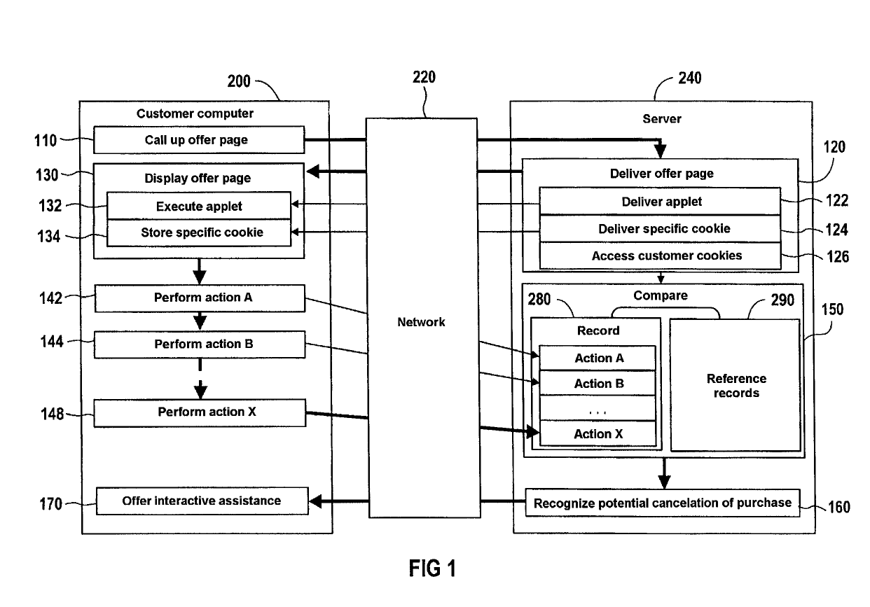

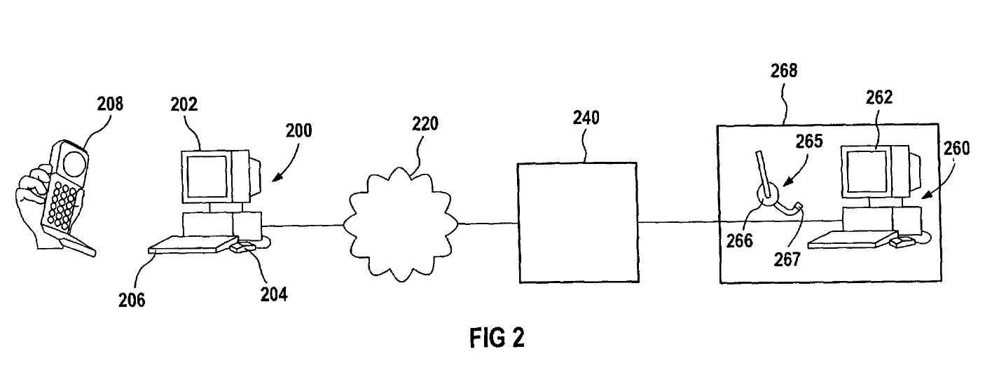

FIG. 1 shows, as an illustrative embodiment of the invention, a flowchart for a method for operating a communication system. In this case, the communication system shown in FIG. 2 is used as an example to describe the flowchart of FIG. 1.

FIG. 2 shows one embodiment of a communication system. The central components of this communication system are a customer computer 200, a network 220 and a server 240 as the central computer. In this case, the customer computer 200 comprises a screen apparatus 202, a computer mouse 204 and also a keyboard block 206. The network 220 connecting the customer computer 200 and the server 240 comprises at least parts of the Internet.

The Internet is a worldwide local network connecting individual regional and local area networks throughout the world to one another. The Internet is characterized by a standard addressing structure in the form of URL addresses (Uniform Resource Locator). In this context, primarily the TCP/IP (Transport Control Protocol/Internet Protocol) is used for data transmission on the Internet. The WWW (World Wide Web) is a hypertext-based information service on the Internet in this context. In the WWW, the HTTP (Hypertext Transfer Protocol) is used, and can be used to transfer information in the form of HTML documents (Hypertext Markup Language). The WWW essentially has a client/server structure. This means that typical functions are based on a dialog-like exchange of information between one of the clients and at least one server. In this context, a server is a computer providing databases, programs or services for clients on the network. By way of example, a web page or home page in the form of an HTML document is stored, i.e. placed in memory, on a server and from there can be retrieved by any location on the network. The client referred to within the client/server structure is the computer, which a user uses to interchange data with the server. For this purpose, the user uses a browser, which can be implemented on the client computer. In this context, a browser is a program that can be used to load an HTML document from a server and to display it on the client computer. In the simplest case, a formatted hypertext is displayed; in extensions, graphics, sound effects and applets, amongst other things, are added which are appropriately embedded in the HTML document. For this, the browser has to support the extensions accordingly, however.

The customer computer 200 can be connected to the Internet as a client computer via a public telephone network or another means of connection that permits Internet access. The server 240 is able to store at least one offer page from a supplier relating to its offers, comprising products and/or services, as a web page.

In a first step 110 of the flowchart shown in FIG. 1, a customer calls up the offer page stored on the server 240 by operating the customer computer 200 as appropriate. To do this, the customer tells the browser which is installed on the customer computer 200 and displayed on the screen apparatus 202 the address of the offer page, for example by operating the keyboard block 206. After an appropriate start signal, for example as a result of pressing the enter key on the keyboard block 206, the browser loads from the server 240 the offer page stored there via the Internet. To this end, in a step 120 of the flowchart, the server 240 delivers the retrieved offer page to the browser running on the customer computer 200 via the Internet so that, in a step 130 of the flowchart, the browser displays the offer page on the screen apparatus 202 as appropriate.

At the same time as the offer page is delivered in step 120, the server 240 delivers, in a step 122 of the flowchart, an applet, for example in the form of a Java applet, which is integrated into the offer page. In a further step 124, a cookie specific to the offer page is delivered. In a further step 126, the server 240 accesses, via the Internet, any cookies specific to the offer page which may have been set when the offer page was retrieved previously and which are stored on the customer computer 200.

In this context, a cookie is understood as meaning an information packet which a server delivers to a browser running on a client computer for storage on the client computer at the same time as when a web page stored on the server is retrieved. Whenever said client computer accesses the web page, the browser is able to deliver the stored cookie to the server. In this context, cookies may contain virtually any desired information. The cookie technique can be used to record, amongst other things, statistical data about a client computer. If a web page receives back the cookie that it set at an earlier time, then the gain in information is that, by way of example, the client computer is recognized again. In addition, the cookie technique can be used to recognize whether and how a particular client computer looks up particular web pages again and/or in what sequence. This can be used to obtain, amongst other things, knowledge for marketing actions. Since only the client computer is identified, the user remains anonymous in the first instance. Only if the user himself informs the web page of personal data, for example in the form of an email address, a customer number and/or a credit card number, can these personal data also be incorporated in cookies from this web page. The result of this is that, when the user next retrieves the aforementioned web page, he automatically presents himself together with his personal data and can be identified by means of these data. Generally, cookies can be prevented from being stored on the client computer by making an appropriate setting in the browser.

An applet is a program that can be integrated into a web page and can generally be executed only by a browser. When a web page is retrieved from a client computer, the applets integrated in the web page are loaded with the web page and are executed by the browser running on the client computer. In this context, applets are written using the programming language Java, for example, and reference is then made to Java applets. In this regard, the concept of Java applets is fundamental to the use of Java programs within the scope of the Internet. A crucial feature in this context is, amongst other things, that the programs developed using Java are platform independent, that is to say that they are capable of running under very different operating systems on all current client computers. This independence is achieved as a result of the concept of the virtual machine, which is central to Java. In this context, a Java compiler uses a source code of a Java program to generate a machine-independent byte code, which can be regarded as being a machine code for a virtual machine. This virtual machine is emulated in the respective client computer using the Java interpreter. This means that Java applets are likewise platform independent and are reliable for use in networks in the sense that a Java applet, loaded via a web page, on the client computer on which it is currently running cannot access other files or programs on the client computer and, in particular, cannot delete or modify any files. Applets can, however, create network connections to the server from which they have been loaded. This provides the option of interacting with applications on the server. In addition, applets in cookies on the client computer are able to request stored information.

Provided that the browser has been set appropriately, in a step 134 of the flowchart, the browser on the customer computer 200 stores on the customer computer 200 the offer page's specific cookie which the server 240 delivered in step 124. In addition, the applet delivered in step 122 is executed by the browser on the customer computer 200 in a step 132 of the flowchart. The assumption in this case is that the browser is able to execute the applet and, on the basis of its setting, is also permitted to execute it. In this case, the program started on the customer computer 200 when the applet is executed in step 132 has the task of recording the actions A to X performed by the customer in the subsequent steps 142 to 148, and of reporting each of the actions A to X to the server 240 via the Internet in real time. In this context, within the scope of the Internet, real time means the same as immediately and as virtually without delay.

In this case, the actions A to X performed by the customer in steps 142 to 148 comprise operating actions in line with the following list: the customer presses a button on the computer mouse 204 or on the keyboard block 206. The customer moves the computer mouse 204 and, associated with this, a mouse pointer on the screen apparatus 202. The customer activates a link on the retrieved offer page, which leads to another point within the retrieved offer page. The customer changes from the retrieved offer page to other pages, which are linked to the offer page, by operating the customer computer 200 as appropriate. The customer activates standard assistance etc. which is available on the retrieved offer page.

The program running on the customer computer 200 by means of the applet reports all the aforementioned operating actions to the server 240 via the Internet in real time. In this context, if the computer mouse 204 is moved, the path of movement of the computer mouse 204 is also transmitted at the same time. On the server 240, the reported actions A to X are continuously entered in a record 280. In addition, besides the aforementioned operating actions, the lengths of time required for these actions, pauses between the operating actions and also customer-specific data, insofar as they can be ascertained from the cookies which are read in step 126, are also included in the record 280.

In this context, by way of example, frequent jumping to and fro between the offer page and pages which are linked to it and also excessive waiting times between the individual operating actions are signs that the customer is uncertain and are hence an indicator of an increased risk that the offer page will be left without an order being placed.

On the server 240, the reported operating actions are evaluated in a step 150 of the flowchart by virtue of the record 280 being continuously compared with reference records 290. In this context, the aim of the comparison is to ascertain with a prescribable degree of probability that the customer is going to leave the offer page and also pages of the supplier which are linked to the offer page without entering an order for one of the offers. If this is recognized in step 160 of the flowchart on the basis of the continuous comparison in step 150, then the customer on the customer computer 200 is offered interactive assistance in real time in step 170 of the flowchart, said interactive assistance in turn being able to be provided in real time. To offer this assistance, an appropriate window is opened on the screen apparatus 202, for example.

In one embodiment, at the same time as a potential purchase cancelation is recognized in step 160, this is reported on a supplier computer 260 to a supplier sales advisor working there, for example as part of a call center 268. To this end, the supplier computer 260 is connected to the server 240 in an appropriate manner. If the interactive assistance offered to the customer in step 170 is accepted, for example as a result of the customer pressing an OK button provided in the window which has been opened, the sales advisor talks to the customer online via the existing Internet connection. For this purpose, a chat service on the Internet can be used, for example. In this context, the chat service permits written information to be interactively exchanged between the customer computer 200 and the supplier computer 260 in real time. For this purpose, a display on the screen apparatus 202 of the customer computer 200 is split into two, for example, so that one half displays what the customer is entering using the keyboard block 206, and the other half displays what is being entered on the supplier computer 260. The same applies for a display on a screen apparatus 262 of the supplier computer 260.

In another embodiment, the customer accepts the interactive assistance offered in step 170 by entering a telephone number on which he would like to be called back immediately. Once the telephone number has been transmitted as appropriate to the call center 268 online via the Internet, the sales advisor calls the customer on the appropriate telephone number. In this case, the sales advisor telephones the customer without delay such that the customer receives the telephone call while the customer is still at the customer computer 200 with the offer page retrieved.

To this end, as shown in FIG. 2, in one advantageous embodiment, the supplier computer 260 has an associated headset 265, comprising at least one loudspeaker 266 and a microphone 267, so that the supplier computer 260 in conjunction with the headset 265 performs functions of a telephone terminal. In the case of the aforementioned telephone call, it is necessary to ensure that, when the customer computer 200 is connected to the Internet using a modem and a simple, in particular analog, telephone line, a telephone line for a telephone terminal 208 is designed to be able to be operated independently of the telephone line for the customer computer 200, in order to maintain the Internet connection and use of the telephone at the same time. To this end, the telephone terminal 208 is, by way of example, in the form of a mobile telephone with a dedicated mobile telephone line, or the customer computer 200 and the telephone terminal 208 are connected to a telephone line which has at least two channels, for example is in the form of an ISDN line.

In other embodiments, interactive exchange of audio and visual information between the customer and the sales advisor in real time is possible simultaneously, for example. To this end, the customer computer 200, like the supplier computer 260, for example, is likewise equipped with a headset 265, and both computers 200 and 260 are designed to be suitable for Internet telephony. In this context, depending on the fundamental software, Internet telephony permits not only voice transmission and the conventional chat service of the Internet, but also transmission of files and videos and also joint drawing of an image. In an expanded refinement, the computers 200 and 260 are also equipped with cameras, so that the functional scope of Internet telephony permits the customer and the sales advisor to see one another on the screen apparatus 202 and 262.

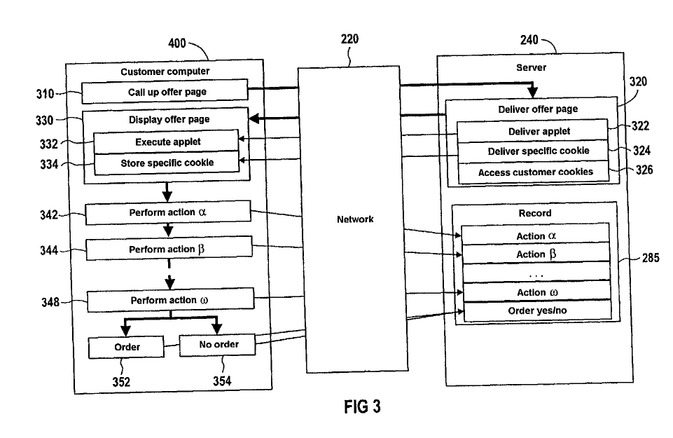

The flowchart in FIG. 3 is used to explain how, for one embodiment, during the comparison in step 150 of the flowchart in FIG. 1, appropriate reference records 290 are determined and refined further whenever the offer page is retrieved. Like the flowchart in FIG. 1, in the flowchart in FIG. 3, an arbitrary further customer computer 400 calls up the offer page in a first step 310, and this offer page is subsequently delivered by the server 240 in a step 320 and is displayed on the customer computer 400 in a step 330.

When the offer page is delivered in step 320, an applet is delivered at the same time in a step 322. The applet delivered is executed by the browser on the customer computer 400 in step 332, whereupon the browser starts a program on the customer computer 400 which permits further operating actions by the customer on the customer computer 400 to be recognized and transmitted to the server 240 via the Internet. In addition, the program started by means of the applet permits access in step 326 to all the cookies stored on the customer computer 400. Thus, besides the offer page's specific cookie that was set when the offer page was retrieved at an earlier time, the cookies from other web pages are also read.

In this context, the cookie specific to the offer page makes it possible to identify whether one and the same customer computer 400 repeatedly retrieves the offer page. If the cookies store individual customer data, such as an email address, a customer number and/or a credit card number, it is even possible to identify the customer. This means that it is possible, amongst other things, to evaluate whether the customer is looking up the offer page for the first time or on a repeated occasion and whether or not he has already made a purchase.

Access to all the cookies stored on the customer computer 400 additionally makes it possible to analyze, a posteriori, which web pages other than those of the supplier have been called up. This allows a comprehensive customer profile to be created.

In another step 324, a cookie which is specific to the offer page is delivered and, in step 334, is stored on the customer computer 400 by the latter's browser for subsequent instances of the offer page being requested.

The actions α to ω performed on the customer computer 400 in steps 342 to 348 after the offer page has been displayed are reported to the server 240 via the Internet by the program initialized by the applet, and are entered in a record 285 on the server 240. In this case, the actions performed on the customer computer 400 by the customer are operating actions which have already been described for FIG. 1. Furthermore, lengths of time required for the operating actions, pauses between the operating actions and also customer-specific data, insofar as they can be ascertained from the cookies which are read in step 326, are included.

Finally, the customer places an order for one of the offers in step 352, or the customer leaves the offer page in step 354 without placing an order, for example by changing to a web page which is not linked to the offer page. The program initialized by the applet transmits the placement or nonplacement of an order to the server 240 via the Internet, and the aforementioned information is noted in the record 285 on the server 240. This concludes the record 285 for a customer's visit to the offer page.

The aforementioned record 285 is created whenever the offer page is retrieved. When there is a sufficient number of the aforementioned records 285 available, in particular from different customers, they are evaluated to extract reference records 290 which indicate purchase cancelation with a prescribable degree of probability. In this context, the aforementioned reference records 290 can be determined, by way of example, using a learning structure, for example a neural network. In this regard, the records 285 are supplied to the learning structure in an appropriate manner. In this case, implementing the learning structure on the server 240 has the advantages that, whenever the offer page is retrieved in line with the flowchart shown in FIG. 1, the reference records 290 can be refined, and the reference records 290 can be automatically and constantly matched to changed customer responses.

While embodiments of the invention have been described above, many more embodiments are within the scope of the invention as set forth in the following claims.

I claim:

1. A method for operating a communication system, comprising the following steps:
a) recognizing, via a central computer, that a customer computer has retrieved an offer page for at least one offer from a supplier;
b) receiving, via the central computer, at least one report of operating actions performed on the customer computer relative to the offer page;
c) evaluating, via the central computer, the reported operating actions; and
d) offering interactive assistance to the customer computer when the evaluating step indicates with a prescribable degree of probability that the customer computer will not enter an order.

2. A method as claimed in claim 1, wherein the evaluating step comprises evaluating time sequences, duration, or frequency of one or more operating actions.

3. A method as claimed in claim 1, wherein the operating actions comprise operating a keyboard, operating a mouse, jumping between the offer page and other pages linked to the offer page, jumping between the other linked pages, or selecting standard assistance for the offer page.

4. A method as claimed in claim 1, further comprising, after the recognizing step, the step of the central computer accessing specific customer data for the customer computer and/or for the customer, wherein the specific customer data is stored in the customer computer.

5. A method as claimed in claim 4, further comprising the step of evaluating the specific data.

6. A method as claimed in claim 5, wherein the receiving step and/or the steps of evaluating the reported operating actions or evaluating the specific data occur in real time.

7. A method as claimed in claim 1, wherein the step of offering interactive assistance occurs in real time.

8. A method as claimed in claim 1, wherein the step of offering interactive assistance comprises offering real time reciprocal exchange of information between the customer and a supplier page.

9. A method as claimed in claim 8, wherein the reciprocal exchange of information comprises communication by telephone.

10. A method as claimed in claim 1, further comprising the step of, when the assistance is offered, reporting in real time the result of the evaluating step on the supplier page.

11. A method as claimed in claim 1, wherein the offer page is stored on the central computer.

12. A method as claimed in claim 1, wherein the central computer and the customer computer are connected via the Internet.

13. A method as claimed in claim 12, wherein the operating actions are reported online.

14. A method as claimed in claim 12, wherein the step of offering interactive assistance occurs online.

15. A method as claimed in claim 12, further comprising the step of the central computer receiving a report of operating actions and/or accessing the specific customer data via a cookie or an applet.

16. A method as claimed in claim 12, further comprising the step of reciprocally exchanging information between the customer and the supplier page via an online chat service.

17. A communication system comprising a server configured to:
a) recognize that a customer computer has retrieved an offer page for a product or service;
b) receive at least one report of operating actions performed on the customer computer in a context of the offer page;
c) evaluate the operating actions; and
d) offer interactive assistance to the customer computer when the evaluating step indicates with a prescribable degree of probability that the customer computer will not enter an order.

18. A communication system as claimed in claim 17, further configured to receive the report and/or access specific customer data stored in the customer computer via a cookie or an applet.

19. A communication system as claimed in claim 17, wherein the operating actions comprise operating a keyboard, operating a mouse, jumping between the offer page and other pages linked to the offer page, jumping between the other linked pages, or selecting standard assistance for the offer page.

20. A communication system as claimed in claim 17, further configured to receive the report, evaluate the operating actions, and offer interactive assistance in real time.
